(19) United States
(12) Patent Application Publication
(10) Pub. No.: US 2009/0119221 A1
(43) Pub. Date: May 7, 2009

(54) System and Method for Cryptographically Authenticated Display Prompt Control for Multifunctional Payment Terminals

(76) Inventors: Timothy Martin WESTON, Cedar Park, TX (US); David SPILLER, Cumming, GA (US)

Correspondence Address: FISH & RICHARDSON P.C., P.O. BOX 1022, MINNEAPOLIS, MN, 55440-1022, US

(21) Appl. No.: 11/935,187

(22) Filed: Nov. 5, 2007

(51) Int. Cl. H04L 9/30; G06Q 20/00; G06Q 30/00

(52) U.S. Cl. 705/76; 705/64

(57) ABSTRACT

This disclosure provides various embodiments of systems and methods for secure communications. In one aspect, the system for secure communications in a retail environment comprises a first display for presenting content to a customer, a first secure payment module comprising a first data entry device and a first secure processor, and a first controller. In some instances, the first controller is communicably coupled to the first display and the first secure payment module. Additionally, the first controller may be adapted to authenticate the first secure payment module, establish a secure communications link between the first controller and the first secure payment module, receive a first source of content, provide a portion of the content to the first display, and selectively enable or disable the first data entry device.

### TECHNICAL FIELD

This disclosure relates to a system and method for secure communications in a retail environment, and more particularly to a secure logical communications link between a secure payment module and a controller created by cryptographically authenticating devices handling sensitive information in the retail environment.

### BACKGROUND

In recent years, retail environments have evolved into elaborate point-of-sale (POS) facilities providing a wide variety of customer services, such as fuel dispensing, car washing, ATM access, money order access, and credit/debit card transactions. Additionally, it has become desirable to offer advertisements and additional sales to customers from third party venders at the retail environments. However, there has not been an ideal system or method available to retailers providing these additional capabilities without raising a significant risk of unauthorized access.

In a traditional retail environment, card data supplied from a customer purchasing products or services is transmitted in an unprotected form from the input system to the POS system, and from the POS system to a network host which performs authentication of the card data. This design allows unauthorized parties to easily intercept customer card data by tampering with the transmission line, especially if the transmission line is Ethernet or a satellite link.

As unauthorized access has become an increasing problem, a number of government and industry agencies have begun proposing stricter guidelines and requirements for retail environment security. One type of enhanced security restriction is the physical requirement that displays within retail environments should directly interface with a secure module in order to allow the secure module to control the PIN entry device (PED). Another security requirement is that the PED must control the prompts that request the entry of PINs and clear-text data. Further, the PED must set a direct interface between the PED keypad and the secure module when a prompt requests the entry of a PIN or other clear-text data. Once the direct interface is set, these PEDs must either (1) be able to cryptographically authenticate all prompts that request the entry of PINs and clear-text data originating from the POS terminal before being displayed or (2) store the prompts in the PED to prevent them from being modified. The idea behind these requirements is that they would synchronize the display on the screen to the state of the PED, thus preventing attacks such as where the PED is in a clear-text data entry mode while the PED displays a command requesting the entry of secure information. In these situations, the customer would enter his or her PIN at a time when the PED would not encrypt the data, thus leading to potential PIN exposure to unauthorized parties.

These requirements leave solution providers with two undesirable options. In the first, the retail environment must have two displays—one for the normal retail environment interface/video that is not “secured,” and another display which would be directly connected to the PED and would only perform PIN/secure prompt functions. This solution is undesirable because it is likely to cause customer confusion and could lead to the multiple screens becoming out of sync. The second solution is to redesign the existing retail environments with a secure chip controlling the display. A major downside to this solution is the loss of enhanced video display support because the video accelerator required for the enhanced video display would not be a secure chip. Additionally, software for the new platform would require an expensive and time-consuming redesign, adding significant cost and complexity to the system while simultaneously reducing the functionality available to and required by customers. A reasonable alternative providing the level of security intended by the new requirements, the functionality desired by customers, and the enhanced capabilities embraced by advertisers and third-party content providers is required.

Others have attempted to protect retail environments from unauthorized access and attacks. One example is U.S. Patent Application No. 2007/0033398 to Robertson et al. (“Robertson”) assigned to Gilbarco Inc. of Greensboro, N.C. Robertson discloses a system using selective encryption to protect sensitive customer information from unwanted intrusion or interception in the retail environment. Robertson teaches that before any content is presented on the display, a controller within the system attempts to verify the content. Once verified, the content can be presented to the customer on the display. Additionally, the system can selectively encrypt data such that only confidential data entered by the customer is encrypted. However, even if the content cannot be verified by the system, the unverified content can still be presented to the display by disabling the data entry device so that no input from the customer can be entered or accepted when unverified content is presented.

The primary weakness of Robertson lies in its failure to adequately protect customers and retail environments against attacks for unauthorized components inserted into or communicably coupled to the system. For instance, an unauthorized and potentially malicious controller or other component may be inserted into the system and supplied with verifiable content. In that instance, the content, having been verified, allows the data entry device to be enabled and entry of sensitive information into the data entry device. That sensitive information may then be intercepted by the unauthorized controller and stored or forwarded for future unauthorized or malicious uses. The system disclosed by the present Application, however, protects the customer and the retail environment from similar attacks by creating a secure communications link and trust relationship between the secure payment module and the controller. The secure communications link is created through device authentication between the components themselves, providing a trusted environment where components are authenticated and the transfer of confidential and other private information is secure.

### SUMMARY

This disclosure provides various embodiments of systems and methods for secure communications. In one aspect, the system for secure communications in a retail environment comprises a first display for presenting content to a customer, a first secure payment module comprising a first data entry device and a first secure processor, and a first controller. In some instances, the first controller may be communicably coupled to the first display and the first secure payment module. Additionally, the first controller may be adapted to authenticate the first secure payment module, establish a secure communications link between the first controller and the first secure payment module, receive a first source of content, provide a portion of the content to the first display, and selectively enable or disable the first data entry device. In some embodiments, in order to authenticate the first secure payment module, the first controller may be further adapted to request a copy of a public key certificate with the first secure payment module, receive a copy of the certificate, and subsequently, authenticate the public key certificate.

Some or all of these aspects may be further included in respective systems or other devices for executing, implementing, or otherwise supporting suitable secure communications. The details of one or more embodiments of the present disclosure are set forth in the accompanying drawings and the description below. Other features, objects, and advantages of the present disclosure will be apparent from the description and drawings, and from the claims.

### DESCRIPTION OF DRAWINGS

FIG. 1 is a basic diagram illustrating an embodiment of the basic system architecture for current retail environments;

FIG. 2 illustrates a high-level diagram of one embodiment of a solution capable of providing a significant level of security without sacrificing functionality for the illustrated embodiment of FIG. 1;

FIG. 3 is a detailed block diagram illustrating an expanded system architecture for the illustrated embodiment of FIG. 1;

FIG. 4 illustrates a sequence diagram for a method establishing a secure communications link between the controller electronics and the secure payment module within the illustrated environment of FIG. 1;

FIG. 5A is a flowchart diagram illustrating the boot sequence for the secure payment module within the illustrated environment of FIG. 1;

FIG. 5B is a flowchart diagram illustrating the boot sequence for the controller electronics within the illustrated environment of FIG. 1; and

FIG. 6 is a flowchart diagram illustrating the process of displaying information on the retail environment display while selectively enabling and disabling the data entry device of the secure payment module within the illustrated environment of FIG. 1.

### DETAILED DESCRIPTION

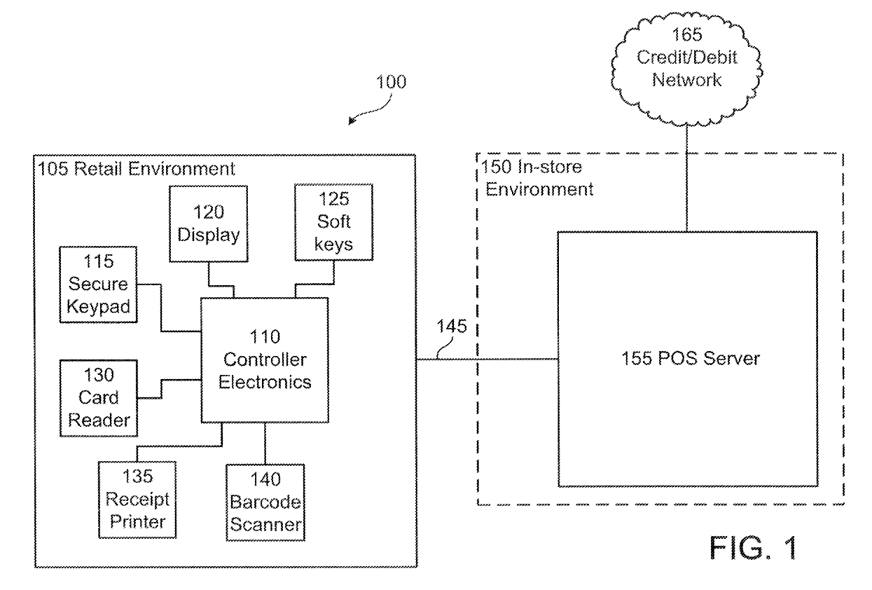

FIG. 1 illustrates one embodiment of the basic system architecture for a retail environment 105. System 100 includes the retail environment 105, an in-store environment 150, an in-store point-of-sale (POS) server 155, an RS-485 serial connection 145 between the retail environment 105 and the in-store POS server 155, and a credit/debit network 165. The system 100 may be implemented as a fueling environment, an automated teller machine (ATM), or other unattended payment terminals such as a kiosk or vending machine needing to accept both personal identification numbers (PIN) and non-PIN data entry. In the current embodiment, the retail environment 105 is comprised of a plurality of modules, including a secure keypad 115, a display 120, a set of soft keys 125, a card reader 130, a receipt printer 135, a barcode scanner 140, and a set of controller electronics 110 that controls each of the aforementioned modules. Further, each module listed above may be a distinct physical entity such that independent exchange and replacement of each module is possible without requiring the exchange or replacement of the entire retail environment 105. In the present embodiment, the POS server 155 acts as the master controller to the entire system, while the controller electronics 110 act as a slave to the POS server 155. In other embodiments, the controller electronics 110 may be able to perform some or all of the tasks of the retail environment 105 independently of the POS server 155. In some embodiments, a plurality of retail environments 105 may exist such that multiple customers may interact with the system 100 at a given time. One example of a plurality of retail environments 105 is a fueling environment's frontcourt, wherein multiple fuel dispensers provide a plurality of drivers with the ability to refuel and pay at the fueling dispenser simultaneously.

In more advanced retail environments 105, the controller electronics 110 may enable and control a VGA screen for playing full-motion video, communicate directly with fueling hydraulics, manage a touch screen, and perform biometric processing, among other actions. Importantly, an advanced set of controller electronics 110 may provide the retail environment 105 with the ability to present multimedia such as advertising or entertainment, as well as other rich-content for customers' consumption. In some embodiments that include an advanced set of controller electronics 110, the operator of the retail system 100, or authorized third parties, may provide customers with the option to purchase additional goods or services through additional interaction with the retail environment 105.

The modules of the retail environment 105 are common to systems accepting both secure (e.g., PIN data) and non-secure (e.g. zip code) customer information. The retail environment 105 includes a secure keypad 115 for entering the customer information into the system in response to appropriate prompts. Depending on the prompt received from the controller electronics 110, the secure keypad 115 may accept information provided by the customer to the controller electronics 110 as ciphertext for sensitive information, or as clear-text for non-sensitive information. A display 120 is also present in the retail environment 105. In the current embodiment, the display 120 is under the control of the controller electronics 11O. To ensure that the prompts shown on the display 120 match the type of entry at the secure keypad 115, the controller electronics 110 can control both modules concurrently. If the prompt provided to the display 120 from the controller electronics 110 requires input of the confidential customer information, the secure keypad 115 ensures that data is encrypted and provided to the controller electronics 110 so that any unauthorized party attempting to intercept the data will find it difficult to determine the actual value of the customer information provided. In addition to the secure keypad 115 and display 120, the retail environment 105 includes soft keys 125 that may be programmed to cooperate with a menu presented on the display 120 to facilitate additional interaction with the customer, a card reader 130 for reading debit, credit, or smart cards used by customers to pay for the goods and services purchased, a receipt printer 135 for printing receipts memorializing the processed transactions, and a barcode scanner 140 for reading barcode-based information from items such as loyalty cards, coupons, or gift cards.

The in-store environment 150 includes the POS server 155. In the fueling environment, the POS server 155 authorizes customer transactions, such as fueling, car washes, or other merchant transactions within the store. One or more POS terminals (not pictured) may be available within the in-store environment 150 for use by operators to conduct retail transactions. These POS terminals are served by the POS server 155. The POS server 155, as described above, is the main controller (or computer) that controls and coordinates the activities of the POS system. In some embodiments, more than one POS server 155 may be present within the in-store environment 150.

In the embodiment of FIG. 1, information is exchanged between the retail environment 105 and the POS server 155 via an RS-485 serial communication line 145, or any other suitable method of communication. Due to the security benefits inherent in hard-line communications, a physical connection between the two locations provides the most security and is the preferred method of communication. However, some embodiments may use a wireless communication link to transfer data between the retail 105 and in-store environments 150.

The in-store environment 150, and specifically the POS server 155, is communicably coupled to a credit/debit network 165 to allow authentication of customers' payment information with the appropriate authority, such as the Visa or MasterCard networks. Standard methods of communication with those networks may be used to process the customer transactions at the retail environment 105 or at one of the POS terminals. Suitable methods of communication include Ethernet, dial-up connections, and satellite communication, among others.

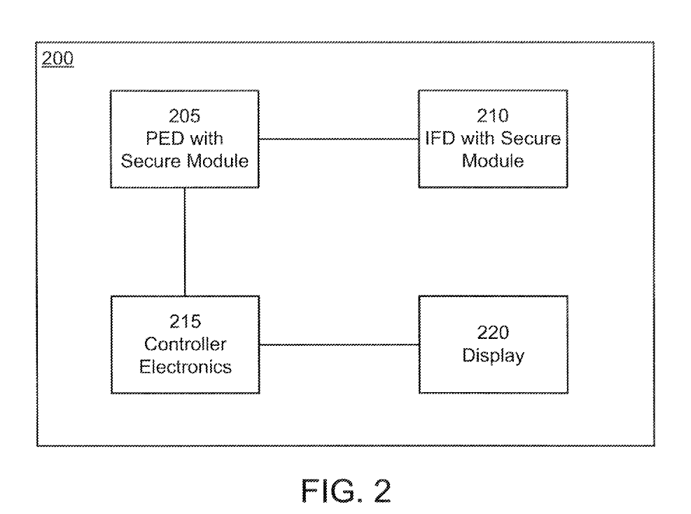

Referring now to FIG. 2, there is illustrated a high-level block diagram of a proposed retail environment 200 employing a modular POS terminal configuration designed to satisfy security requirements proposed by certain regulatory and industry agencies. In this configuration, the PED 205, the interface device (IFD) 210, the display 220, and the controller electronics 215 are physically separate units. Similar to the system of FIG. 1, the controller electronics 215 control the PED 205, the IFD 210, and the display 220, providing the functionality each requires and coordinating the interaction between the components.

The PED 205, which includes a secure keypad, contains a secure module operable to encrypt the confidential information (e.g., PIN values in the present embodiment) received from customers before the information is transmitted to the IFD 210. The IFD 210 includes a secure module in order to decipher the information received from the PED 205. The IFD 210 may include a card reader capable of retrieving information from an integrated circuit card (ICC), a standard debit card, and/or a standard credit card. If the card being read is an ICC, the IFD 210 may be able to read both the integrated circuit (IC) embedded in the ICC and the magnetic stripe of the card. If the IFD 210 is unable to read and retrieve magnetic stripe data from cards, a separate magnetic stripe reader may be added to the system to ensure that standard methods of payment are accepted. As stated above, the display 220 is controlled by the controller electronics 215 and presents prompts and various types of multimedia to customers during their interaction with the system. In this design, the display used for the PED 205 can be the same display as the user interface of the retail environment 200, thereby decreasing the number of displays necessary from two to one. However, the PED 205 is not directly connected to the display 220. Instead, the PED 205 interfaces with the controller electronics 215, which in turn directly connect to the display 220.

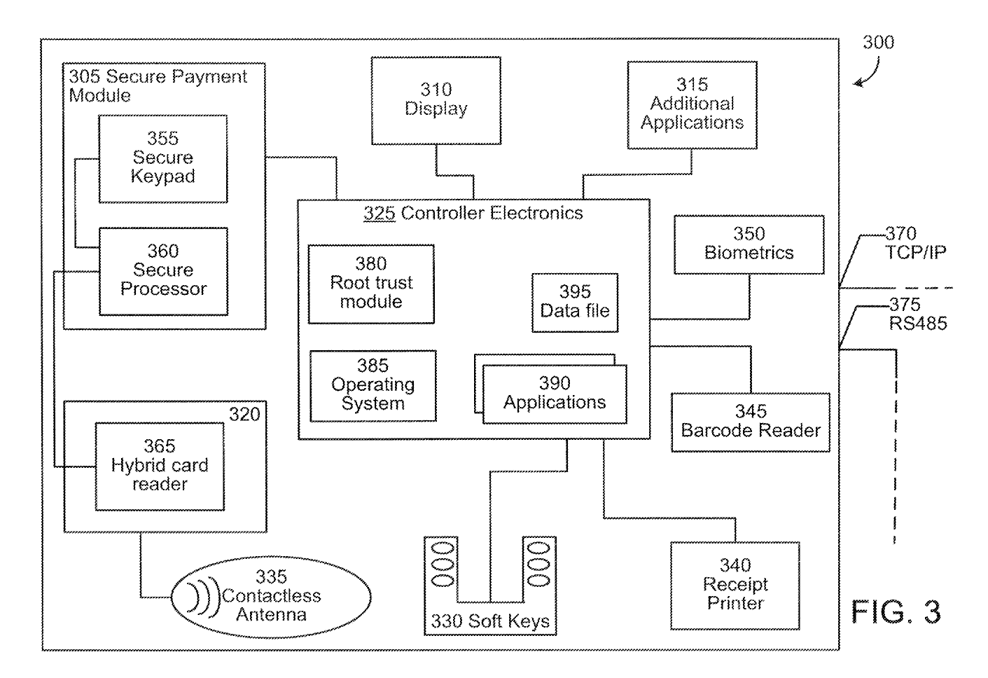

FIG. 3 provides a detailed block diagram illustrating an expanded system architecture of the exemplary embodiment of FIG. 1. System 300 focuses primarily upon the architecture of the retail environment 300, illustrating an embodiment providing enhanced physical security in addition to an improved level of communications security. The retail environment 300 includes a secure keypad 355 and a secure processor 360 housed within a secure payment module 305, which is a tamper-resistant and tamper-responsive enclosure used to protect the encryption keys and the electronics from tampering. The combination of the secure keypad 355 and the secure processor 360 is similar to the PED 205 described in FIG. 2. The hybrid card reader 365, capable of reading ICCs, debit cards, and credit cards, is also enclosed within a tamper-resistant and tamper-responsive enclosure 320. By protecting these critical input devices, the physical security of the retail environment 300 is enhanced.

In this embodiment, the secure processor 360 and the hybrid card reader 365 are communicably connected through a communication line. In some embodiments, the connection may be an RS-232 serial connection using RJ-45 plugs and jacks. In still other embodiments, the secure processor 360 and the hybrid card reader 365 may be co-located in a single module. For instance, the hybrid card reader 365 may be physically located within the secure payment module 305 to create an even more secure environment. The hybrid card reader 365 may act as a slave to the secure processor 360, providing it with data received from customer cards. While the connection between the card reader 365 and the processor 360 may not be physically secured, sensitive data from the card reader 365 may be encrypted prior to transmission to the secure processor 360. The secure processor 360 and the card reader 365 may authenticate each other prior to exchanging information, such as by performing a two-way challenge authentication procedure. Once trust is established, any sensitive data (e.g., magnetic card data, PINs for smart card transactions, etc.) from the card reader 365 will be sent to processor 360 in encrypted format.

Other modules included within the retail environment 300 are similar to those described in FIGS. 1 and 2. Additional modules may include a contactless antenna 335 for use with radio frequency identification (RFID) tags or other wireless information exchange techniques. A biometric module 350 may also be included for payment or identification via biometric means, such as fingerprint reading or iris scanning. A miscellaneous module 315 providing additional retail environment 300 features may be included as well. An example of possible additional features may be the iX® Platform Features created by Dresser-Wayne, Inc. for use in fueling environments. A set of soft keys 330 may be programmed to supplement the display 120 to allow additional methods of interaction with the retail environment, and a receipt printer 340 may also be provided for printing receipts. Finally, a barcode reader 345 may be present to allow for the reading of barcode-based items such as loyalty cards, coupons, or gift cards. All modules within the retail environment 300 are housed in a secure location, such as a fuel dispenser cabinet or ATM housing, which is locked and inaccessible from the outside, except for maintenance purposes.

Extending from this embodiment's retail environment 300 are two communication lines, a TCP/IP connection 370 and an RS-485 serial connection 375. Similar to the embodiment of FIG. 1, the RS-485 serial connection 375 may be used to communicate with the POS server 155 and the in-store environment 150. The TCP/IP connection 370 may be used to provide more dynamic data to the retail environment 300 for which additional bandwidth is necessary, such as multimedia advertising, detailed graphical displays, and similar types of data. Data sent with the TCP/IP connection 370 may be provided by the retailer and the POS server 155 or a third-party content provider. Other connections may interface with the retail environment 300 for additional communication lines required or desired by a specific embodiment.

To further secure the retail environment 300, a variety of cryptographic techniques may be used, including public key/private key encryption. Public key/private key encryption provides the ability to encrypt data using a public key which can only then be decrypted by a receiving party or component possessing a private key associated with the public key. A popular public key/private key encryption algorithm is the RSA public-key cryptography system developed by Ronald L. Rivest, Adi Shamir, and Leonard M. Adleman in 1977. The challenge of public-key cryptography is developing a system in which it is extremely difficult to determine the private key. This is accomplished through the use of a one-way function. By using a one-way function it is relatively easy to compute a result given some initial input values. However, it is extremely difficult to determine the original values starting with the result. In mathematical terms, given a value x, computing f(x) is relatively easy. However, given the result f(x), computing x is very difficult. The one-way function used in the RSA algorithm is a multiplication of prime numbers. It is mathematically simple to multiply two large prime numbers, however it is extremely time-consuming to factor them for most very large primes. Public-key cryptography makes use of this property of large prime numbers by implementing a system that uses two large primes to build a private key, and the product of the primes to build a public key. A simplified example of the RSA algorithm is described as follows:

Key Generation

By selecting two primes, P=11 and Q=23, the RSA algorithm is used to generate the numbers N, E, and D in the following manner:

N=P×Q=11×23=253

PHI=(P−1)(Q−1)=220

The public exponent E is calculated so that the greater common divisor of E and PHI is 1. In other words, E is relatively prime with PHI. For this example:

E=3

In the RSA algorithm, N and E are used as the public keys. The private key D is the inverse of E modulo PHI. By using an extended Euclidian algorithm, the example private key is determined as D=147.

Encryption

To encrypt data, for example a number M=4, the following procedure is used to form an encrypted message C:

C=M̂E mod N=4\hat{0}̂3 mod 253=64

Thus, the example encrypted message is 64.

Decryption

The encrypted message will be decrypted to form a decrypted message M from the encrypted message C using the following procedure:

M=C\hat{0}D mode N=64\hat{0}̂147 mode 253=4

thereby recovering the original message data. Although the above example used small prime numbers for illustrative purposes, in actual practice the prime numbers selected for public key/private key cryptography are very large numbers. In the present embodiment, 2048 bit RSA-cryptography is used. Other known methods, such as the Diffie-Hellman algorithm (DH) or the Data Encryption Standard (DES), may be used as the method of cryptography in alternative embodiments.

Additionally, digital signatures may be used to authenticate modules and components in the retail environment 300. A digital signature is a cryptographic means through which the identity of an originating party may be verified. Typically, the digital signature is created through the use of a hash function and encryption using the sending party or component's private key, although other methods may be used. In the present embodiment, a hash function may be applied to a message or set of data (shown as HASH(data)) such that a message digest is generated. The message digest allows a message or set of data of an arbitrary length to be reduced to a fixed length. After generating the message digest using the hash function, the message digest may then be encrypted by the sending party (or component) prior to delivering the message and the message digest. Upon receipt at the receiving party (or component), the digital signature may be authenticated by decrypting both the message and message digest, applying an identical hash function to the message, and comparing the decrypted message digest sent from the originating party with the message digest created at the receiver's end. If the message digests are identical, the digital signature is considered authenticated. If the two do not match, either a third party or outside component is attempting to impersonate the originating party or component, or the message itself has been altered since the originating party initially calculated the message digest. In either case, a possible security breach has occurred and suitable actions should be taken. In the present embodiment, the hash algorithm applied may be a SHA1 one-way hash resulting in a 160-bit message digest. In alternative embodiments, a stronger hash algorithm, such as SHA256, may also be used if desired.

The retail environment 300 and its modules may contain a number of public and private keys and digital signatures. Each embodiment may have a different set of keys and/or signatures according to the actual requirements of that system. The following chart provides a list of the pertinent keys within the present embodiment of FIG. 3. This list is not meant to be exhaustive, and includes only those keys pertinent to the present embodiment. In this example, all public keys other than the root certificate authority key are stored in minimal certificate form with a digital signature or chain of signatures that can ultimately be traced to the root. Additionally, each certificate may contain the key type and/or meta information such that key misuse is limited and/or eliminated, allowing each key to be used for only a single purpose.

TABLE 1
Pertinent Cryptographic Keys for FIG. 3

| Name | Description |
|---|---|
| RootCApub | Public key of root CA - used to verify certificates. Self-signed. |
| RootCApriv | Matching private key, used to sign certificates for other keys. |
| | The most critical key to keep secure |
| SPMToCEpub | Used by controller electronics to verify responses from SPM |
| SPMToCEpriv | Used to sign SPM responses to controller electronics |
| CEOSAuthpub | Used by controller electronics' root trust module to verify controller electronics OS |
| | image |
| CEOSAuthpriv | Used to sign valid controller electronics OS images |
| CEAppAuthpub | Used by controller electronics OS to verify controller electronics application code |
| CEAppAuthpriv | Used to sign valid controller electronics application binaries |
| CEPromptAuthpub | Used by controller electronics application to validate file containing all numbered |
| | prompts |
| | May be used to authenticate a sub-prompt certificate |
| CEPromptAuthpriv | Used to sign file containing prompts |
| | May be used to sign a customer prompt certificate. |
| CEBAAuthpub | Used with controller electronics root trust module to validate it to SPM |
| CEBAAuthpriv | Signs valid controller electronics root trust module |

Returning to FIG. 3, the controller electronics 325 include three software components used in the operation of the retail environment 300: a secure root trust module 380, an operating system 385, and a set of applications 390. The root trust module 380 of FIG. 3 is a software program or secure chip whose functionality allows the operating system 385 to be authenticated upon initialization and startup of the retail environment 300. The secure root trust module 380 may be implemented as a flash memory integrated circuit soldered to the controller electronics 325. In some instances, the secure root trust module 380 may instead be embodied by a secure chip capable of authenticating various portions of the controller electronics 325, including the controller electronics 325 itself, in addition to providing identification information that allows other components to authenticate the controller electronics 325. The root trust module 380 may also be implemented in other non-volatile memory that interfaces the controller electronics 325 such as read-only memory (ROM), programmable read-only memory (PROM), mask-programmed ROM (MPROM), battery-backed static random access memory (RAM), or a secure digital (SD) card, among others.

In the present embodiment, the operating system 385 of the controller electronics 325 may be Microsoft Windows CE, Red Hat (or another version of) Linux, Unix, or another suitable operating system. The operating system 385 may be stored on a Secure Digital (SD) card, embedded into onboard flash memory, or stored in any other suitable location. The operating system 385 is responsible for device drivers, network interfaces, system libraries, and for launching any applications 390 for use in the retail environment 300. The applications 390 loaded by the operating system 385 may also be stored on a Secure Digital (SD) card, embedded into the onboard flash memory of the retail environment 300, or stored in any other suitable location. The applications 390 may collectively control all aspects of the display 310 and the retail environment interface (i.e., the secure keypad 355, the secure processor 360, and the hybrid card reader 365), as well as the communications of the controller electronics 325 to other modules and devices.

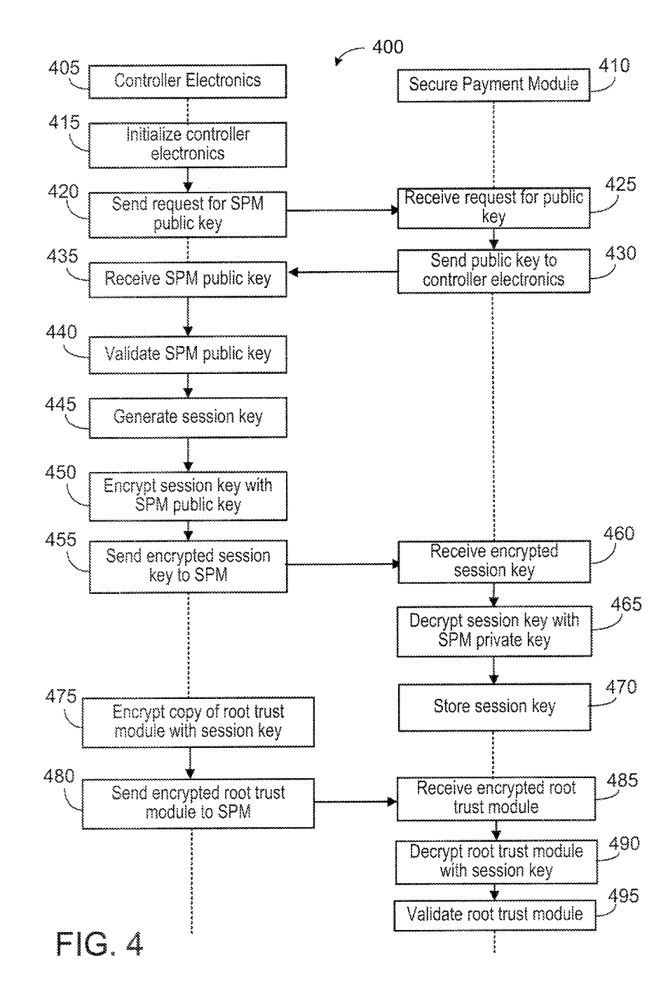

In this embodiment, the display 310 is not required to be physically secure. Due to the logical security implemented between the controller electronics 325 and the display 310, and the fact that the display 310 is not directly connected to the secure processor 360, the current system is protected from attempts by unauthorized agents to intercept or alter the data meant for presentation on the display 310. Secure information regarding customers' PIN numbers or magnetic card data is not provided to the display 310 from the controller electronics 325. Instead, that information is sent via the secure communications link between the controller electronics 325 and the secure payment module 305. Additionally, information transmitted between the secure payment module 305 and the controller electronics 325 is encrypted such that outside agents attempting to intercept the data would find understanding the information extremely difficult and time-consuming. The details of this encryption are described with regards to FIG. 4. Because the display 310 is not physically secured to the retail environment 300, exchanging the display 310 with a new model becomes a simple and inexpensive task, saving operators time and costs. Additionally, the display 310 does not need to include a secure chip, nor will the retail environment 300 require a redesign to enhance its security.

In order to add a level of security to software stored in the controller electronics 325, some embodiments may allow only cryptographically-authenticated software to be run. In effect, a trust model may be developed to ensure that all software present in the retail environment 300 is authentic. In the present embodiment, the trust model may rely upon digital signatures to authenticate the software. If software attempts to load that does not have a digital signature, or the digital signature it does have is not recognized, the software will not be allowed to run. In order to ensure a secure system, the digital signing of all software may be performed in a secure environment. In one embodiment, the secure environment may employ a process of dual control (split knowledge) when performing cryptographic functions. Additionally, appropriate review procedures should be followed prior to cryptographically signing the software.

With regards to the trust model, cryptographic components may be embedded within the secure root trust module 380, such that the root trust module 380 may cryptographically authenticate the operating systems 385. Additionally, cryptographic data allowing other components to authenticate the secure root trust module 380 may also be embedded therein. The following components, among others, may be embedded within the root trust module 380 in some embodiments:

1. RootCApub certificate;

2. CEOSAuthpub certificate;

3. CEBAAuthpub certificate; and

4. E_{CEBAAuthpriv}(HASH(root trust module contents)).

Referring to Table 1 above, the RootCApub certificate may represent the public key of the root certificate authority and may be used to verify other certificates. In other embodiments, the RootCAPub certificate may not be embedded within the secure root trust module 380. In those instances, other digital signatures may be used to chain validate the origin and authenticity of the root trust module 380. Next, the CEOSAuthpub certificate may be used to verify the operating system image 385 being loaded. In some instances, the CEOSAuthpub certificate may not be embedded within the root trust module 380. Instead, the certificate may be contained in the operating system binary code may be authenticated using the RootCApub certificate to establish trust. This CEOSAuthopub certificate may then be used to authenticate the operating system image. The CEBAAuthpub certificate may be used by the secure modules to validate the root trust module 380. The final component listed, E_{CEBAAuthpriv}(HASH(root trust module contents)), represents the digital signature of the secure root trust module 380 as encrypted with the CEBAAuthpriv certificate. The root trust module contents are hashed by a specific hash algorithm to generate a unique digital fingerprint. After hashing the contents, the fingerprint is encrypted using the CEBAAuthpriv certificate, the private key associated with the root trust module 380. A component attempting to authenticate the root trust module may use the root trust module's public key, CEBAAuthpub, to decrypt the value. Using the identical hash algorithm, HASH(root trust module contents) may be calculated. If, after comparing the decrypted hash value and the calculated hash value, the values are identical, the root trust module 380 may be considered authenticated.

Operating systems 385 loaded onto the controller electronics 325 may need to be digitally signed before allowed to run. The digital signature may be stamped on the operating system binary, and may be computed with E_{CEOSAuthpriv}(HASH(OS contents)). Using the embedded cryptographic components, the root trust module 380 may authenticate these operating systems by extracting the operating system's digital signature and comparing it to the calculated hash value. The hash value of the operating system may be decrypted using the root trust module's 380 embedded public key value, CEOSAuthpub. Once decrypted, HASH(OS Contents) may be compared to the calculated hash value of the operating system contents. If the values are identical, then the operating system is authenticated and may be booted. If the values do not match, the operating system is not booted and in some embodiments, an error is reported.

Just as the root trust module 380 verifies the authenticity of the operating system 385 before it allows the operating system to start, the operating system 385 must verify the authenticity of the applications 390 that are contained outside the operating system 385 image. Before an application 390 can execute, the operating system 385 may call a special loader function to determine whether the module is allowed to load. At that time, the operating system 385 can generate the value of HASH(Application Contents). This value can then be compared to the D_{CEAppAuthpub}(Application digital signature), the value of the Application digital signature decrypted by the public key CEAppAuthpub. If the values match, then the application 390 will be allowed to load. If they do not match, the operating system 385 will not load that application 390. Each application 390 that is to be run on the controller electronics 325 and is not embedded into the operating system 385 image must be digitally signed before being allowed to run. The digital signature may be stamped onto the Application binary, and may be computed with E_{CEAppAuthpriv}(HASH(Application Contents)).

Finally, authorized applications 390 may be responsible for verifying the authenticity of a package of on-screen prompts to be sent to display 310 for viewing by the customer. Screen displays, information requests, and/or other content that will be provided to the display 310 and in some instances, values showing whether any requested keypad entry should be in secure or non-secure mode, may be stored within a data file 395. The data file 395 may be stored on a Secure Digital (SD) card, flash memory, or other suitable forms of volatile or non-volatile memory that may be coupled to the controller electronics 325. In some embodiments, the data files 395 may be an XML file, a simple text file, or any other file format compatible with the operating system 380 and the applications 390 accessing the file 395. Data prompts within the data file 395 may be textual, graphical, or consist of binary blobs describing how the prompt is to operate, in addition to other suitable formats. In some embodiments, the data file 395 can be digitally signed with the signature E_{CEPromptAuthpriv}(HASH((prompt file)). When the application 390 requests that the secure payment module 305 perform confidential or non-confidential data entry, the application 390 may verify the digital signature of the data file 395 before displaying the prompts on the display 310 and enabling the secure keypad 355 to allow data entry. The verification process may be performed by comparing the value of HASH(prompt file) to D_{CEPromptAuthpub}(prompt file digital signature). If the values match, the prompt file may be authenticated and the prompts provided to the display. If the values do not match, the prompts may not be displayed and appropriate security notifications should be made to check for potential unauthorized access. In other instances, if the values do not match, the prompt may still be presented at the display 310, although the secure keypad 355 may be disabled to avoid entry of confidential data while the secure payment module 305 is in a non-secure state. Alternatively, a customer prompt key pair may be substituted for the CEPromptAuth key pair. In this embodiment, the customer prompt public key must be signed by CEPromptAuthpriv to generate the prompt certificate. Before the certificate is issued, the customer's security procedures must be reviewed to ensure that the certificate will be kept secure after issuance. Thus, for the secure keypad 355 to be enabled, the prompt file must be digitally signed and authenticated.

Having performed the authentication of the software on the controller electronics 325, the components of the secure payment module 305 and the controller electronics 325 must validate each other as legitimate and trusted devices before full operation of the retail environment commences. First, the controller electronics 325 must validate the secure keypad 355 and secure processor 360 within secure payment module 305 (collectively referred to as “SPM 305”) before the controller electronics' software completes its startup sequence. In some embodiments, validation of the SPM's 305 identity may take place implicitly by the establishment of a session key with the SPM 305. By verifying that the SPM 305 can establish a link with session-level encryption, the SPM 305 may verify that it can sign a challenge from the controller electronics 325 with SPMToCEpub. Because the SPM certificate for SPMToCEpub is authenticated by the root certificate authority, it may be considered a legitimate module. A further description of establishing a secure communications channel/link between the SPM 305 and the controller electronics 325 is discussed with relation to FIG. 4.

Continuing the mutual authentication, the SPM 305 must validate the controller electronics 325 before the secure keypad 355 may be controlled by the controller electronics 325. To validate the controller electronics 325, the initial handshake with the SPM 305 from the controller electronics 325 may include sending a copy of the root trust module 380. The SPM 305 can determine the hash value for the root trust module 380 after the module is received. The SPM 305 can also extract the digital signature of the root trust module 380. The SPM 305 may also extract the CEBAAuthpub certificate from the secure root trust module 380. First, the CEBAAuthpub certificate may be validated with a copy of RootCApub stored within the SPM 305. In other embodiments, the CEBAAuthpub certificate may be chain validated using other certificates signed by the root certificate authority. If the CEBAAuthpub certificate is cryptographically authenticated, the CEBAAuthpub certificate may be used to verify the digital signature of the root trust module 380. If the computed hash of the root trust module 380 matches D_{CEBAAuthpub}(Root trust module Digital Signature), then the root trust module 380 may be considered cryptographically authenticated. After authentication, further commands may be sent to the SPM 305. In some alternative embodiments, the controller electronics 325 may include a secure chip or processor that can perform a two-way authentication with the SPM 305. In those embodiments, the secure chip or processor may perform the authentication techniques necessary to create the secure communications link between the controller electronics 325 and the SPM 305.

FIG. 4 illustrates a sequence diagram for a process 400 of securing a communications link between the secure payment module 305 and the controller electronics 325 as described in relation to the illustrated embodiment of FIG. 3. The design of retail environment 300, like most retail environments, provides an opportunity for unauthorized access to the data being transmitted within the system by third parties. In order to eliminate this threat, a mechanism may be implemented to secure the communications link between the controller electronics 405 and the secure payment module (SPM) 410. Referring to the structure of FIG. 4, the left side of the diagram illustrates actions at the controller electronics 405, while the right side illustrates actions at the SPM 410. The SPM 410 of this embodiment may be similar to the SPM 305 of FIG. 3, and may contain a secure keypad and a secure processor.

At step 415, the controller electronics 405 are initialized. In some embodiments, the initialization of the controller electronics 405 may be similar to the start-up process described with regards to the embodiment of FIG. 3. At step 420, the controller electronics 405 send a request to the SPM 410 requesting a copy of a public key or public key certificate associated with the SPM 410. The SPM 410 may store a copy of its public key certificate locally so that the certificate may be provided to other components within the fuel dispenser attempting to create a secure communications link with the SPM 410. In some instances, the public key certificate may be the SPMToCEpub certificate previously described in Table 1. A private key corresponding to the public key certificate is stored securely and locally within the SPM 410. In some instances, the private key may be the SPMToCEpriv key, also described in Table 1.

At step 425, the SPM 410 receives the controller electronics' 405 request. In response, the SPM 410 sends its public key certificate to the controller electronics 405 at step 430. At step 435, the controller electronics 405 receive and store the SPM public key certificate for future use. In order to confirm that the SPM 410 is a trusted component, the controller electronics 405 may validate the SPM public key certificate at step 440. Validation of the certificate may be performed differently in various embodiments. For instance, one embodiment may have the controller electronics 405 verify the SPM public key certificate's digital signature by validating the digital signature with a certificate issued by a root certificate authority certificate associated with the digital signature, as described in FIG. 3. Other methods of public key certificate validation known in the art may also be performed in order to validate the authenticity of the public key certificate and the SPM 410, such as chain validation of the digital signature.

Once the SPM's public key certificate and thus, the SPM 410, are validated, the controller electronics 405 may generate a session key for encrypting further communications between the controller electronics 405 and the SPM 410 at step 445. In some embodiments, the session key may be generated by the controller electronics 405 through the use of a random number generator (RNG) or a pseudorandom number generator (PRNG), the latter being a computer algorithm that produces data which appears random under analysis. For instance, the PRNG may use system entropy to seed data, using the randomness of system conditions to increase the difficulty attackers may face in attempting to derive the initial conditions that were used to generate the keys. Although the current embodiment of FIG. 4 uses only one session key, in other embodiments the controller electronics 405 may generate multiple session keys for use with various types of communications. For instance, the controller electronics 405 may generate three keys: a key-encryption key (KEK) used to encrypt updated session keys that are generated periodically or in response to a predetermined event prior to delivering the new session keys to the SPM 410, a session key for communications sent from the SPM 410 to the controller electronics 405 (SessionSPMToCE), and a session key for communications sent from the controller electronics 405 to the SPM 410 (SessionCEToSPM). In some embodiments cipher-block-chaining may be implemented. In some of those embodiments, initialization vectors (IVs) associated with each session key may also be generated by the controller electronics 405 and encrypted with the associated session keys, such that the both the session keys and IVs are sent to the SPM 410. The use of IVs allow a block cipher to be executed in any of the several streaming modes of operation to produce a unique stream independent from other streams produced by the same encryption key without requiring a lengthy re-keying process, thus reducing the time necessary to establish the secure communications link.

Returning to the embodiment of FIG. 4, at step 450 the controller electronics 405 encrypt the session key with the public key included with the validated SPM public key certificate. The encrypted session key is sent to the SPM 410 at step 455 and received by the SPM at step 460. Upon receipt, at step 465 the SPM 410 decrypts the session key using the private key associated with the public key certificate used to encrypt the session key. Once decrypted, the SPM 410 stores the session key for future use at step 470.

Prior to the transmission of any commands and messages between the controller electronics 405 and the SPM 410, the SPM 410 may validate the controller electronics 405 in order to create a two-way trusted relationship and ensure a secure communications link between the components. Previously at step 440, the controller electronics 405 validated the SPM 410 by authenticating the SPM public key certificate, and in effect, the SPM 410. In order to validate the controller electronics 405, at step 475 the controller electronics 405 encrypt a copy of the root trust module, such as root trust module 380 of FIG. 3, with the previously-generated session key. Once encrypted, the root trust module is sent to the SPM 410 at step 480. At step 485, the SPM 410 receives the encrypted root trust module. Once received, the SPM 410 uses the session key to decrypt the root trust module at step 490. Once decrypted, at step 495 the SPM 410 attempts to validate the root trust module, and in effect, the controller electronics 405. In some embodiments, the validation process may be performed in a manner similar to the root trust module validation performed in FIG. 3. In those embodiments, the root trust module may be embedded with a public key certificate originating from a trusted certificate authority. Upon receiving and decrypting the root trust module, the SPM 410 may validate the public key certificate to ensure that the root trust module, and therefore the controller electronics 405, are to be trusted. Once the root trust module is validated, the communication link between the controller electronics 405 and the SPM 410 is fully authenticated, and a secured communication link and trust relationship are created between the two components.

Once fully authenticated, communications between the controller electronics 405 and the SPM 410 may be encrypted with the session key. Because only the controller electronics 405 and the SPM 410 have knowledge and access to the session key, communications encrypted with the session key are provided a high level of security from outside agents. However, additional steps may be taken to further secure communications between the components. In one embodiment, a random sequence number may be established for command/response information as well as for asynchronous status information being generated by the SPM 410. For instance, a random sequence number X may be embedded in a first message from the controller electronics 405 to the SPM 410. In response to the first message, the number X may be incremented to X+1 and embedded into the response sent by the SPM 410. Upon receipt, the controller electronics 405 may review the embedded sequence number, expecting to find X+1. If the sequence number is not as expected, actions may be taken to respond to a potential attack, such as shutting down, warning the customer and/or employee, and/or logging the information. In a second embodiment, Cipher Block Chaining (CBC) may be used to further secure the communications channel. By encrypting a given set of clear-text data with some block cipher algorithm in CBC mode, a chain of blocks may be created such that each block is dependent on the proper encryption of the block before it. Since this interdependence exists, the components can ensure that none of the clear-text data bits that were input into the encryption have been changed, thus creating a message authentication code. When CBC is enacted, the final block of each message must be padded to the correct block size. If the correct message authentication code is not produced, appropriate action in response to a possible attack may be taken. Finally, the session key may be refreshed at certain intervals or in response to predetermined events. When refreshing, the controller electronics 405 may generate a new session key (or set of keys) using the RNG or the PRNG Using the previously generated KEK, the new session key may be encrypted and sent to the SPM 410. The SPM 410 may then, upon receipt, decrypt and store the new session keys. Once stored, communications may continue using the new session keys. This way, in the unlikely event that a session key is intercepted or deciphered, the refreshing function allows for a recovery of the communication link's secure status.

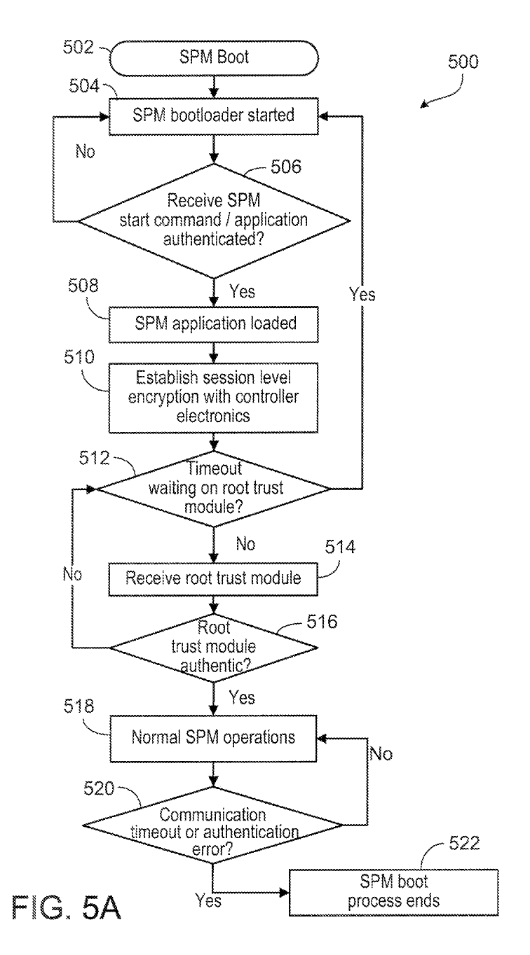

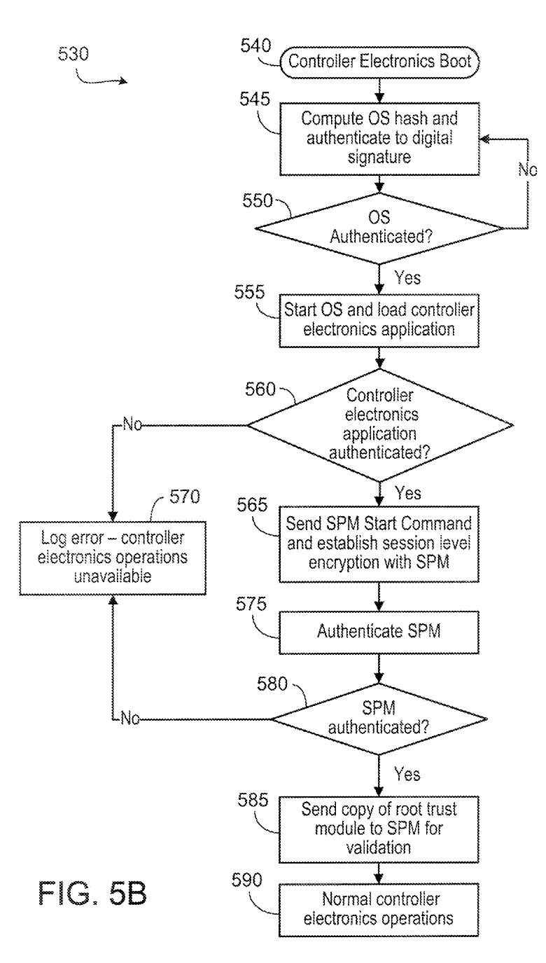

FIGS. 5A and 5B provide flowchart diagrams of the SPM and controller electronics' boot sequences, including their mutual authentication. Referring to FIG. 5A, the SPM begins its boot process 500 and initialization at step 502. At step 504, an SPM bootloader is started during or after the SPM's initialization. The SPM bootloader, software running on the SPM's secure processor, initializes the SPM hardware and its communication links. At step 506, the boot process 500 determines whether the SPM has received the SPM start command from the controller electronics and whether the SPM application software is cryptographically authenticated. If the answer to either one of these determinations is no, the process returns to step 504 for another opportunity to receive the SPM start command and/or authenticate the software. When both result in a yes, the process continues to step 508 where the SPM application is loaded.

At step 510 the SPM establishes session-level encryption with the controller electronics. Establishing the session key may be performed similar to the method described in FIG. 4. Once session-level encryption has been established, at step 512 a determination of whether a timeout has occurred while waiting for a valid root trust module is made. As described with respect to FIG. 4, during mutual authentication the SPM receives a copy of the controller electronics' root trust module. After receiving a copy of the root trust module, the SPM may validate the controller electronics through validation of the root trust module and create a secure communications link between the components. If a timeout occurs, the boot process returns to step 504 to wait for the SPM bootloader to begin. If no timeout occurs, the SPM boot process receives a copy of the root trust module 380 at step 514.

At step 516, the SPM boot process determines whether the root trust module received is the authentic root trust module from the controller electronics. To validate the root trust module, the SPM determines the hash value for the root trust module as it is being received. At the same time, the SPM extracts the digital signature of the root trust module from the copy it receives. The SPM may also extract the CEBAAuthpub certificate from the root trust module. To begin the authentication process, the CEBAAuthpub certificate is validated with a copy of RootCApub stored in the SPM. Once the CEBAAuthpub certificate is cryptographically authenticated, it may be used to verify the digital signature of the root trust module. If the computed hash of the root trust module matches D_{CEBAAuthpub}(Root Trust Module Digital Signature), then the root trust module is cryptographically authenticated. Other suitable methods for authentication may be used in alternative embodiments. If the received root trust module is not authenticated, the boot process may return to step 512 to determine whether another root trust module has been received or whether a timeout occurred while waiting for a new root trust module. If, however, the root trust module received is authenticated as the root trust module from the controller electronics, normal SPM operations may occur at step 518. These normal operations may include receiving commands from the controller electronics, responding in kind, and operating the secure keypad as instructed by the controller electronics. Step 520 continually determines whether a communication timeout or authentication error occurs during normal operations. If neither occurs, normal SPM operations continue at step 518. However, if either error is received, the SPM boot process ends at step 522 and any additional commands from the controller electronics will require the process to be reinitialized.

FIG. 5B represents the boot process 530 of the controller electronics. At step 540, the process is initiated. At step 545, the hash value of the operating system being loaded onto the controller electronics is computed. For authentication purposes, that hash value is compared to the digital signature embedded within the operating system. At step 550 the controller electronics review the comparison to determine whether the operating system is cryptographically authenticated. If the value calculated and the digital signature retrieved from the operating system match, then the operating system is authenticated. Once authenticated, the operating system will start at step 555. If, however, authentication fails, the boot process will return to step 545 where another attempt to authenticate the first operating system may occur. Alternative embodiments may provide an exit routine to the boot process so that each operating system attempting to be loaded will only try a predetermined number of times before an error is returned and the boot process is ended.

In addition to starting the operating system, at step 555 the boot process attempts to load the application necessary to allow the controller electronics to perform normal operations. As described in detail with regards to FIG. 3, each application that is not contained within the operating system image, and that is to be loaded onto the controller electronics, must be authenticated by the operating system. In the present embodiment, this authentication is performed by first having the operating system generate a hash value of the application's contents. Next, the application's encrypted digital signature is retrieved from the application's coding, decrypted by the appropriate public key, and compared to the generated hash value. At step 560, the boot process determines whether these values are identical. If they are not, then the process moves to step 570 where the error may be logged in a system file and a notice provided to the operator. Because of the failed loading, the application will not be available and the boot process may be exited. If, however, the application is authenticated, the controller electronics may provide an SPM Start Command to the SPM at step 565 (see step 506 of FIG. 5A). Once the SPM application is loaded (see step 508 of FIG. 5A), the controller electronics and the SPM establish session-level encryption. In some embodiments, establishing the session key may be performed in a manner similar to that described in FIG. 4.

At step 575, the controller electronics attempt to cryptographically authenticate the SPM. By establishing the session-level encryption, the SPM's identity may be implicitly validated. In verifying that the SPM can establish a link to the controller electronics with session-level encryption, the SPM verifies that it can sign a challenge from the controller electronics with SPMToCEpub. Because the SPM certificate for SPMToCEpub is authenticated by the root certificate authority, it may be considered a legitimate module and may be considered authenticated. Next, step 580 determines whether the session-level encryption at step 575 and the SPM's authentication at step 580 were successful. If not, the boot process moves to step 570 where an error may be logged in a system file and a notification sent to the operator of the system. Because the authentication failed, the operations of the SPM will not be available to customers until the process succeeds. If the SPM is authenticated, then at step 585 the controller electronics may send the SPM a copy of the root trust module so that the SPM may validate the controller electronics. The validation process is described in steps 514 and 516 of FIG. 5A. Once the mutual authentication is successful, normal controller electronics operations occur at step 590.

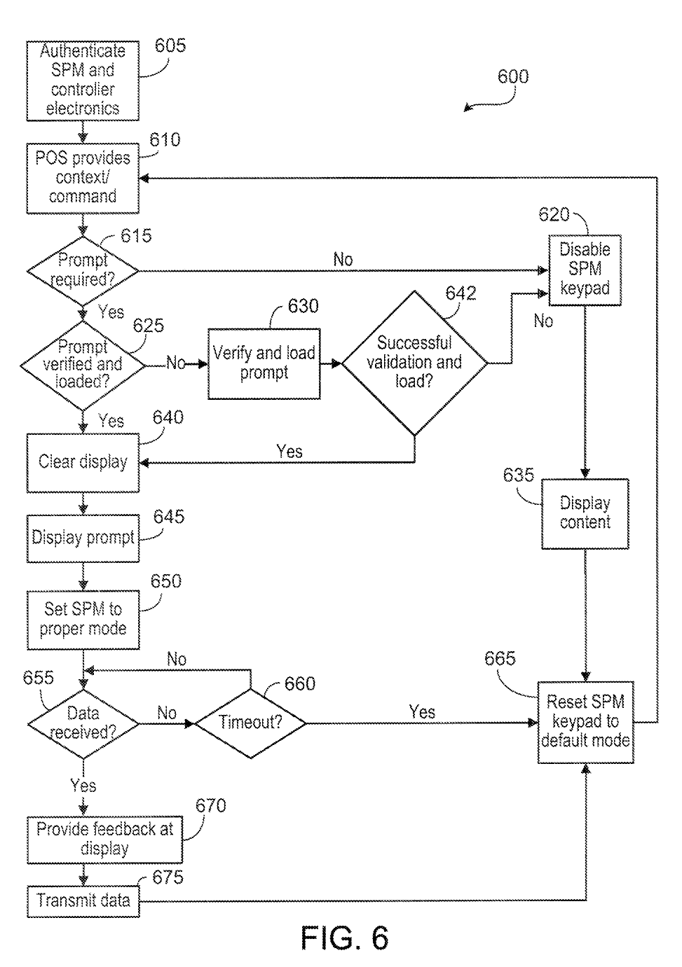

FIG. 6 is a flowchart diagram illustrating the process used to display content in the retail environment. At step 605, the SPM and controller electronics authenticate each other and create a secure communications link over which data may be encrypted with a session key. This authentication process is further described with regards to FIGS. 3-5. Once the two modules have established the appropriate security link, process 600 moves to step 610, where the POS provides content or commands to the controller electronics. In typical retail environments, the POS controls all content, prompts, and requests for PIN and other data entry. As retail environments have become more sophisticated, marketing and other third party content may be provided to the controller electronics for display. In the current embodiment, the controller electronics may receive this content and control the displays directly. In most embodiments, the POS controls the retail environment during transactions.

At step 615, the controller electronics review the commands and content provided by the POS to determine whether a secure prompt will be required. A secure prompt is necessary when information is requested or required from the customer. If it is determined that a secure prompt is not necessary, then at step 620 the controller electronics may, using the secure communications link, disable the SPM keypad so that no information may be entered by the customer. Once the keypad is disabled, the controller electronics allow the display to show the content provided by the POS at step 635. In some embodiments, any content may be displayed if it does not require a secure prompt. By disabling the keypad, an unauthorized party's attempt to have customers enter their confidential information while the keypad is not in a secure data entry mode will fail. The confidential information will not be passed from the keypad to the secure processor, thus preventing successful spoofing or man-in-the-middle attacks. Once the content has been displayed, the process moves to step 665 where the keypad may be reset to its default mode. Upon reset, the process may return to step 610 and new content and commands may be received from the POS.

Returning to step 615, if it is determined that a secure prompt is necessary to perform the commands sent by the POS, the controller electronics determine whether the prompt file has been successfully verified and loaded into the local memory. The prompt file may describe all aspects of the required input. For example, for the “Enter PIN” prompt, the file must indicate that an encrypted keypad input transaction is required. For the “Enter ZIP Code” prompt, the file must indicate that a clear-text data entry transaction is necessary. Should the controller electronics determine that the prompt file has been verified and loaded at step 625, the process continues. If, however, the controller electronics determine that the prompt file has not been verified, then at step 630 the prompt file is verified and loaded. In some embodiments, step 630 may be performed by verifying the digital signature of the prompt file through a comparison of the prompt file's calculated hash value with its digital signature. Other verification techniques may be used in alternative embodiments. At step 642, the controller electronics determine whether the verification and loading process was successful. If so, the process will continue to step 640. If, however, the process was not successful and the prompt file could not be verified or loaded, the SPM's secure keypad is disabled at step 620 to prevent any unsecured entries of sensitive customer information at the keypad.

Moving to step 640, the display is cleared of its current content and/or prompts. Next, the correct prompt from the verified prompt file is presented on the display at step 645. Before the customer may respond to the prompt, and in some instances before the prompt is displayed, the SPM, and specifically the secure keypad of the SPM, is set into the proper mode at step 650. The proper mode may be determined by the information stored within the prompt file. If the file indicates that a prompt requires encrypted keypad input, then the secure keypad at the SPM is set to the proper mode of encryption. On the other hand, if the prompt file indicates that the prompt needs only a clear-text keypad input, then the SPM is set to its clear-text data entry mode.

At step 655, the SPM waits for data to be received from the customer. While it waits, the SPM determines whether a timeout has occurred at step 660. If a timeout does occur, the SPM is reset to its default mode at step 665, and the process returns to step 610 where it will receive another set of content and commands from the POS. If a timeout does not occur, the process returns to step 655 to wait for the appropriate data. Once data is received, the SPM and controller electronics can provide feedback on the display unit for the customer at step 670. Two types of feedback are possible in the current embodiment. First, if the secure keypad is in clear-text data entry mode, the controller electronics can provide the customer input to the display in real-time so that the customer can ensure that the data entered is correct. If, however, the secure keypad is in encrypted mode, the feedback presented to the customer at the display may be limited to a placeholder, such as an asterisk, indicating the number of significant digits entered. For instance, when a 4-digit PIN is entered by the customer, the display will provide four asterisks (“****”) to indicate that four digits have been entered. At step 675, the customer may affirm that the data entered is correct and finalize the entry. The data will then be sent to the POS via the controller electronics, where the transaction is then processed. Once sent, the process moves to step 665 wherein the SPM is reset. From there, the process returns to step 610 and receives additional content and commands from the POS.

While the preceding flowcharts and accompanying descriptions illustrate exemplary processes, the retail environment contemplates using or implementing any suitable technique for performing these and other tasks. It will be understood that these methods are for illustration purposes only and that the described or similar techniques may be performed at any appropriate time, including concurrently, individually, or in combination. In addition, many of the steps in these flowcharts may take place simultaneously and/or in different orders than as shown. Moreover, the retail environment may use methods with additional steps, fewer steps, and/or different steps, so long as the process remains appropriate. Thus, the above description of example embodiments does not define or constrain the disclosure. Other changes, substitutions, and alterations are possible without departing from the spirit and scope of this disclosure, and such changes, substitutions, and alterations may be included within the scope of the claims included herewith.

What is claimed is:

1. A system for secure communications in a retail environment, comprising:
a first display for presenting content to a customer;
a first secure payment module, the first secure payment module comprising a first data entry device and a first secure processor; and
a first controller communicably coupled to the first display and the first secure payment module, wherein the first controller is adapted to:
authenticate the first secure payment module;
establish a secure communications link between the first controller and the first secure payment module;
receive a first source of content, the content comprising one or more prompts to be presented by the first display;
provide a particular one of the prompts to the first display; and
selectively enable or disable the first data entry device.

2. The system of claim 1, wherein to authenticate the first secure payment module, the first controller is further adapted to:
transmit a request to the first secure payment module for a first public key certificate associated with the first secure payment module;
receive the first public key certificate associated with the first secure payment module; and
authenticate the first public key certificate.

3. The system of claim 2, wherein the first public key certificate is associated with a first digital signature issued by a trusted certificate authority.

4. The system of claim 3, wherein to authenticate the first public key certificate, the first controller is further adapted to verify the first digital signature with the trusted certificate authority.

5. The system of claim 2, wherein to establish the secure communications link between the first controller and the first secure payment module, the first controller is further adapted to:
generate a first session key;
encrypt the session key with a first public key embedded in the first public key certificate;
transmit the encrypted session key to the first secure payment module;
encrypt a copy of a root trust module associated with the first controller using the first session key, the copy of the root trust module embedded with a second digital signature issued by the trusted certificate authority; and
transmit the encrypted copy of the root trust module to the first secure payment module.

6. The system of claim 5, wherein to establish the secure communications link between the first controller and the first secure payment module, the first secure payment module is adapted to:
receive the encrypted first session key;
decrypt the first session key using a first private key associated with the first public key certificate, the first private key stored locally and securely at the first secure payment module;
store the session key locally and securely at the first secure payment module;
receive the encrypted copy of the root trust module associated with the first controller;
decrypt the copy of the root trust module using the first session key; and
authenticate the second digital signature embedded in the copy of the root trust module

7. The system of claim 5, wherein the first session key is generated, at least in part, by a pseudorandom number generator using entropy data.

8. The system of claim 1, wherein the first controller is further adapted to validate the first source of content, the first source of content embedded with a digital signature issued by the trusted certificate authority.

9. The system of claim 8, wherein the first controller is further adapted to:
selectively enable the first data entry device if the first source of content is successfully validated; or
selectively disable the first data entry device if the first source of content is not successfully validated.

10. The system of claim 1, wherein the first controller is further adapted to determine whether the particular one of the prompts requests confidential information from the customer.

11. The system of claim 10, wherein the first controller is further adapted to:
if the particular one of the prompts requests confidential information from the customer, set the first secure payment module in a secure mode for receiving customer information at the first data entry device; or
if the particular one of the prompts requests non-confidential information from the customer, set the first secure payment module in a non-secure mode for receiving customer information at the first data entry device.

12. The system of claim 1, wherein information received after the secure communications link is established is encrypted with the first session key.

13. The system of claim 1, wherein the first source of content is received from a third party remote from the retail environment.

14. The system of claim 1, wherein the first secure payment module is located within a tamper-resistant and tamper-responsive enclosure.

15. A method for secure communications in a retail environment, comprising:
establishing a logically secure communications link between a first controller and a first secure payment module, the first secure payment module comprising a first secure processor and a first data entry device;
authenticating a first data file stored with the first controller, the first data file containing a plurality of content;
receiving a request to present a particular one of the plurality of prompts;
if the first data file is authenticated, enabling the first data entry device;
if the first data file is not authenticated, disabling the first data entry device.

16. The method of claim 15, wherein establishing the logically secure communications link between the first controller and the first secure payment module comprises:
receiving, at the first controller, a first public key certificate associated with the first secure payment module, the first public key certificate including a first digital signature issued by a trusted certificate authority uniquely identifying the first secure payment module;
authenticating, at the first controller, the first public key certificate;
generating, at the first controller, a first session key;
encrypting, at the first controller, the first session key with a first public key associated with the first public key certificate;
transmitting the encrypted first session key from the first controller to the first secure payment module;
receiving, at the first secure payment module, the encrypted first session key;
decrypting, at the first secure payment module, the first session key with a first private key corresponding to the first public key certificate, the first private key securely stored at the first secure payment module; and
storing, at the first secure payment module, the first session key.

17. The method of claim 16, wherein establishing the logically secure communications link between the first controller and the first secure payment module further comprises:
encrypting, at the first controller, a copy of a root trust module with the first session key, the root trust module including a second digital signature issued by a trusted certificate authority uniquely identifying the first controller;
transmitting the encrypted copy of the root trust module from the first controller to the first secure payment module;
receiving, at the first secure payment module, the copy of the root trust module;
decrypting, at the first secure payment module, the copy of the root trust module with the first session key; and
authenticating, at the first secure payment module, the second digital signature included with the copy of the root trust module.

18. The method of claim 15, wherein the first data file is authenticated, further comprising:
determining if the particular one of the plurality of prompts requests confidential information from a customer interacting with the retail environment;
if the particular one of the plurality of prompts requests confidential information from the customer, setting the first secure payment module into an encrypted mode; and
if the particular one of the plurality of prompts requests non-confidential information from the customer, setting the first secure payment module into a non-encrypted mode.

19. The method of claim 16, wherein the first session key is generated, at least in part, from pseudorandom system entropy.
